(19) United States
(12) Patent Application Publication
(10) Pub. No.: US 2019/0317661 A1
(43) Pub. Date: Oct. 17, 2019

(54) FACILITATING FIELD DATA COLLECTION USING HIERARCHICAL SURVEYS

(71) Applicant: Dharma Platform, Inc., Washington, DC (US)

(72) Inventors: Jesse Erin BERNS, Washington, DC (US); Michael Roytman, Washington, DC (US); Jennifer Paige GRIFFIN, Chicago, IL (US)

(21) Appl. No.: 16/388,585

(22) Filed: Apr. 18, 2019

Related U.S. Application Data
(63) Continuation of application No. 14/973,279, filed on Dec. 17, 2015, now abandoned.
(60) Provisional application No. 62/249,827, filed on Nov. 2, 2015.

(51) Int. Cl. G06F 3/0484; G06F 16/9535; G06Q 10/10; H04L 29/08; G06F 9/451; G06F 17/24

(52) U.S. Cl. CPC G06F 3/04847; G06F 16/9535; G06Q 10/10; H04L 67/104; G06Q 30/02; G06F 9/453; G06F 17/248; G06F 17/243; G06F 9/451

(57) ABSTRACT

The technology presented here enables low skilled administrators to design a hierarchical survey, low skilled field agents to collect answers to the hierarchical survey, and low skilled field managers to manage and monitor the progress of the field agents. The hierarchical surveys designed can be complex hierarchical surveys comprising multi-stage sampling units. The graphical user interfaces presented to the users are easy to use, and hide the complexity of the hierarchical survey. The user devices can communicate with each other to transmit the hierarchical surveys and the answers received to the hierarchical surveys using peer-to-peer networks, in environments where there is low, or no Internet connectivity.

### CROSS-REFERENCE TO RELATED APPLICATIONS

This application is a continuation of U.S. patent application Ser. No. 14/973,279, filed Dec. 17, 2015, which claims priority to the U.S. Provisional Patent Application Ser. No. 62/249,827, filed Nov. 2, 2015. The aforementioned applications are incorporated herein by reference in their entirety.

### TECHNICAL FIELD

The present application is related to facilitating field data collection using hierarchical surveys, and more specifically to methods and systems that facilitate field data collection with low network connectivity.

### BACKGROUND

None of the hierarchical surveying tools currently in the market provide a unified computer platform for low skilled field agents, field managers, and administrators to design a hierarchical survey, to collect answers to the hierarchical survey, and to analyze the collected answers. In addition, typical online hierarchical survey tools report means, variances, and confidence intervals assuming simple random sampling. In case of more complex multistage hierarchical surveys, a naïve analysis of the hierarchical survey answers would not take into account the covariances introduced by the multistage sampling strategy, thus requiring a time consuming manual analysis of each question in order to arrive at the correct results and uncertainty estimates. Finally, the hierarchical surveying tools require an Internet connection between the devices involved in the hierarchical survey.

### BRIEF DESCRIPTION OF THE DRAWINGS

FIG. 1 is a system for communicating between a plurality of devices using a peer-to-peer communication network, according to at least one embodiment.

FIG. 2 is a flowchart of steps taken in facilitating field data collection, according to at least one embodiment.

FIG. 3 is a first element of the administrator graphical user interface, according to at least one embodiment.

FIG. 4 is a second element of the administrator graphical user interface, according to at least one embodiment.

FIG. 5 is an example of a hierarchical survey template presented to an administrator user, according to at least one embodiment.

FIG. 6A-B, are an example of an administrator user interface configured to formulate a question associated with a question category node, according to at least one embodiment.

FIG. 7 is a first element of the field agent graphical user interface, associated with a field agent device, according to at least one embodiment.

FIG. 8 is a second element of the field agent graphical user interface, associated with a field agent device, enabling the field agent to view the hierarchical survey progress, according to at least one embodiment.

FIG. 9 is a third element of a field agent graphical user interface, associated with a field agent device, according to at least one embodiment.

FIG. 10 is a fourth element of the field agent graphical user interface, associated with a field agent device, according to at least one embodiment.

FIG. 11A is a first element of a field manager graphical user interface, associated with a field manager device, enabling the monitoring of hierarchical survey progress, according to at least one embodiment.

FIG. 11B is the field manager dashboard associated with the field manager graphical user interface, associated with a field manager device, according to at least one embodiment.

FIG. 11C is a notepad enabling the field manager to enter comments associated with a team, a project, or a group of projects.

FIG. 11D is the content dashboard associated with the field manager graphical user interface, according to at least one embodiment.

FIG. 11E is the staff permissions dashboard associated with the field manager graphical user interface, according to at least one embodiment.

FIG. 11F is the content dashboard associated with the field manager graphical user interface, according to at least one embodiment.

FIG. 11G is a field manager graphical user interface enabling the field manager user to manage permissions and privileges associated with a field agent, according to at least one embodiment.

FIG. 12 is an analytics graphical user interface displaying the analytics computed based on the answers received, according to at least one embodiment.

FIG. 13 is a diagrammatic representation of a machine in the example form of a computer system 1300 within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

In this specification GUI and graphical user interface are synonyms.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Field Data Collection

The technology presented here enables low skilled administrators to design a hierarchical survey, low skilled field agents to collect answers to the hierarchical survey, and low skilled field managers to manage and monitor the progress of the field agents. The hierarchical surveys designed can be complex hierarchical surveys comprising multi-stage sampling units. The graphical user interfaces presented to the users are easy to use, and hide the complexity of the hierarchical survey. The hierarchical survey can include a plurality of levels. Each level includes at least one node. The node can represent a question and a corresponding answer. The user devices can communicate with each other to transmit one or more hierarchical surveys for deployment and one or more answers to the hierarchical surveys using a network (e.g., a peer-to-peer networks). The hierarchical surveys and/or the answers can be transmitted in environments where there is intermittent or no Internet connectivity.

Presented here is a computer-implemented method to facilitate field data collection, which includes several components: administrator graphical user interface associated with an administrator user device, a field agent graphical user interface associated with a field agent device, and a field manager graphical user interface associated with a field manager device.

The administrator user device can generate the administrator graphical user interface, which guides a low skilled administrator user in creating a hierarchical survey. The hierarchical survey includes a plurality of levels. Each level can include a node. A first subset of the plurality of levels corresponds to a sampling unit associated with a hierarchical survey stage. A second subset of the plurality of levels corresponds to a question category. A third subset of the plurality of levels corresponds to a question. The administrator user device transmits the hierarchical survey from the administrator user device to the field agent device, using a peer-to-peer network.

The field agent user device can configure a field agent graphical user interface to correspond to the levels associated with the hierarchical survey. The field agent graphical user interface enables the field agent to navigate, without having to complete the node before switching to another node, among the levels and among the nodes associated with the levels. The field agent user device transmits the collected answers to the field manager device using a peer-to-peer network.

The field manager device can configure a field manager graphical user interface to indicate hierarchical survey progress associated with the hierarchical survey. The hierarchical survey progress includes a progress percentage associated with the level in the hierarchical survey, and a progress percentage associated with the node associated with the level.

A device, which can be the field manager device, the administrator user device, or any device with a permission to access the collected answers, can compute analytics based on the collected answers, and display the analytics in an analytics graphical user interface. Alternatively, the analytics can be computed remotely on a remote computer, server, cloud etc.

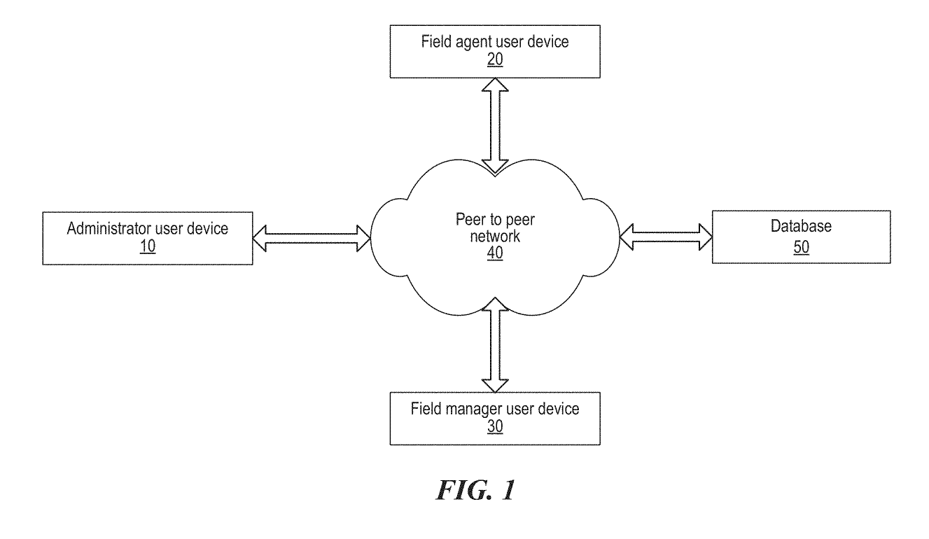

FIG. 1 is a system for communicating between a plurality of devices using a peer-to-peer communication network, according to at least one embodiment. The devices 10, 20, 30 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, the accessories and peripherals of these devices, or any combination thereof.

The devices 10, 20, 30 communicate with each other using the network 40. The network 40 can be a peer-to-peer network. Peer-to-peer network can be connected to the Internet, but does not have to be. The peer-to-peer network can be a mesh network. The peer-to-peer network can use a short range wireless protocol, such as a Bluetooth protocol. The peer-to-peer network can be a cellular network.

The network 40 can be a traditional data network. The network 40 may be any local area network (LAN), metropolitan area network (MAN), wide area network (WAN), a public data network (e.g., the Internet), short range wireless network, or any other suitable packet-switched network, such as a commercially owned, proprietary packet-switched network (e.g., a proprietary cable or fiber-optic network, and the like, or any combination thereof). In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

Database 50 can be stored on an Internet node, a server, a cloud, fixed terminal, station, unit, device, multimedia computer, desktop computer, laptop computer, notebook computer, netbook computer, tablet computer, or any combination thereof. In some embodiments, database 50 includes the field manager user device 30.

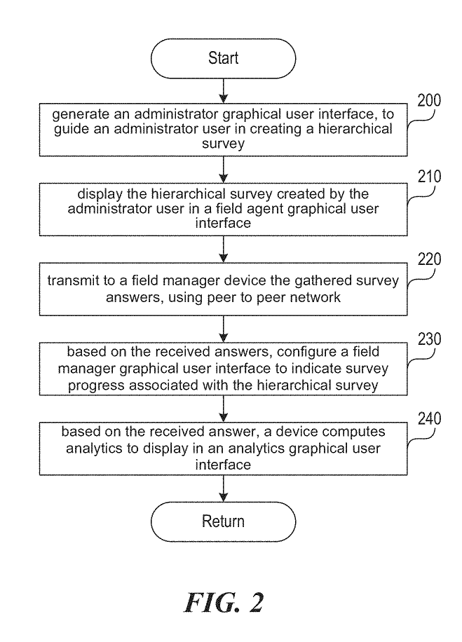

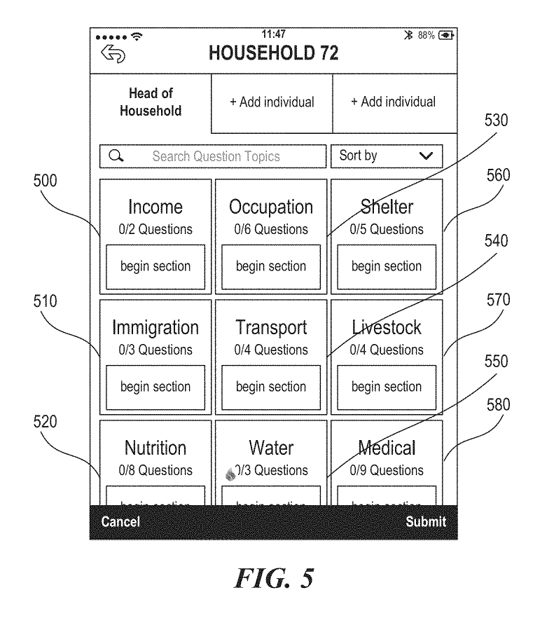

FIG. 2 is a flowchart of steps taken in facilitating field data collection, according to at least one embodiment. In step 200, the administrator user device 10 generates an administrator graphical user interface, to guide an administrator user in creating a hierarchical survey. The hierarchical survey includes a plurality of levels. Each level includes at least one node. Each node has a parent node. Some nodes can have a child node. For example, in one embodiment, the first level in the hierarchical survey has one node and corresponds to a first sampling unit associated with a first hierarchical survey stage, such as a household. The second level in the hierarchical survey has a node that corresponds to a second sampling unit associated with a second hierarchical survey stage, such as an individual. Each node, in the second level corresponds to an individual hierarchical surveyed. For example, if three individuals are hierarchical surveyed, there are three nodes in the second level associated with the hierarchical survey. The third level in the hierarchical survey corresponds to a plurality of question categories. Each question category is a node. The question category is defined by the administrator user and can include shelter, livestock, immigration, water, income, etc., (see FIG. 5, question category nodes 500-580). Each question category node has at least one child node, the child node representing a question associated with the question category node. The fourth level in the hierarchical survey has at least one node and corresponds to the questions associated with the parent node question category. For example, if the question category node is shelter, the question can be “What kind of shelter is this?”.

In step 210, the field agent user device 20 displays the hierarchical survey created by the administrator user in a field agent graphical user interface. The field agent graphical user interface enables the field agent to gather answers to the hierarchical survey questions by navigating among the levels and the nodes without having to complete a node before switching to another node. The gathering of answers, and the navigation of the user interface is simple and enables low skilled agents to gather answers to the hierarchical survey questions. In case of skip logic questions (described below), the field agent graphical user interface does not allow access to a subsequent skip logic question, if the previous question has not been answered. In some embodiments, access to at least one node may be restricted by skip logic. In these embodiments, the node becomes accessible only after another node is marked as completed.

In step 220, the field agent user device 20 transmits to a field manager device 30 the gathered hierarchical survey answers, using communication network 40. The communication network 40 can be a mesh network, or a traditional data network as described above.

In step 230, based on the received answer, the field manager device 30 configures a field manager graphical user interface to indicate hierarchical survey progress associated with the hierarchical survey. The hierarchical survey progress includes a progress percentage associated with each level in the hierarchical survey, and a progress percentage associated with each node associated with each level.

In step 240, based on the received answer, a device computes analytics to display in an analytics graphical user interface. The device can be a field manager device 30, the administrator user device 10, or a user device associated with a user who has subscribed to view the analytics.

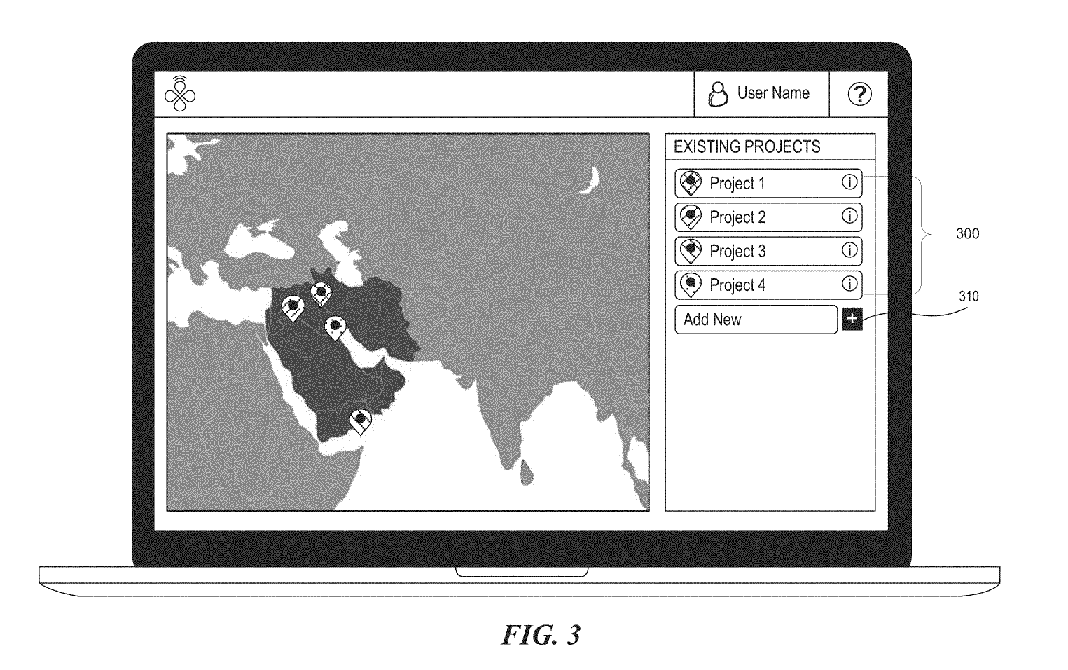

FIG. 3 is a first element of the administrator graphical user interface, according to at least one embodiment. The administrator graphical user interface associated with the administrator user device 10, guides the administrator user in creating a hierarchical survey. We elements 300 enable the administrator user to select an existing project, and to further examine it. GUI element 310 enables the administrator user to create a new project. Each project is associated with a geographical region, such as a country, province, county, state, city, etc. The administrator user interface guides an administrator user in creating a hierarchical survey. As described above, the hierarchical survey includes a plurality of levels. Each level includes at least one node.

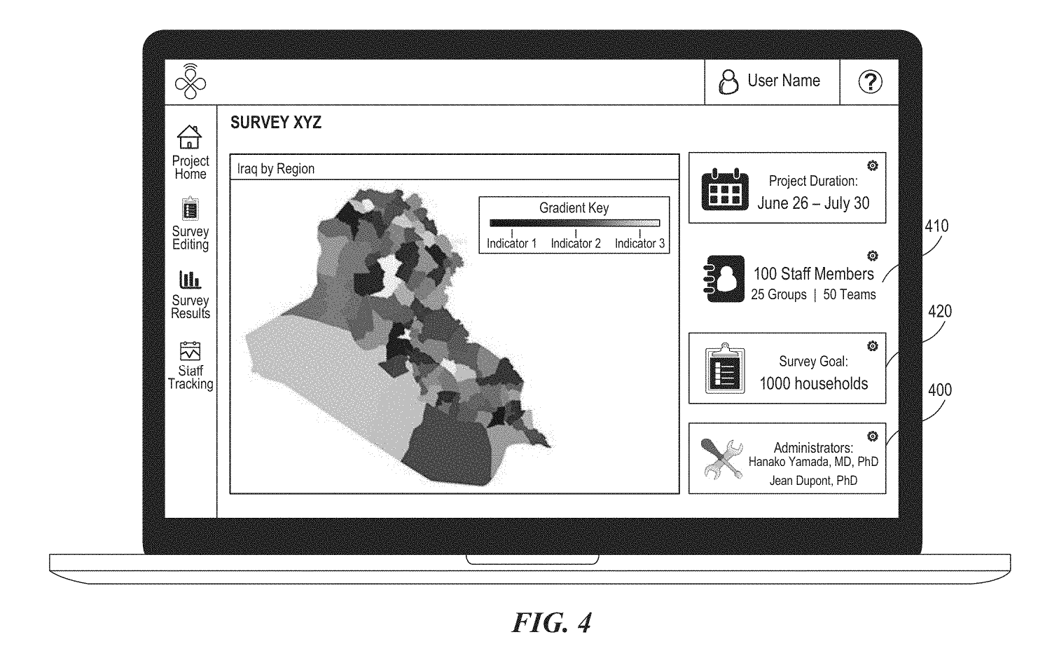

FIG. 4 is a second element of the administrator graphical user interface, according to at least one embodiment. GUI element 400 enables the administrator user to specify access permissions, such as the users, and user IDs, that have administrator user privileges. The administrator user privileges include an access to create the hierarchical survey, an access to monitor hierarchical survey progress, and an access to view hierarchical survey analytics. Further, GUI element 410 enables the administrator user to create field manager user privileges, and field agent user privileges, and associate a user ID with the created privileges. The field manager user privileges comprise an access to monitor hierarchical survey progress, an access to view hierarchical survey analytics, and an access to manage the field agents. The field agent user privileges comprise an access to record answers to the hierarchical survey, and access to view hierarchical survey progress associated with hierarchical surveys to which the field agent is assigned.

GUI element 420 enables the administrator user to specify the sampling unit associated with the first stage of the hierarchical survey. In the example of FIG. 4, the first unit is a household. Further, GUI element 420 enables the administrator to specify the target number of sampling units to hierarchical survey. In the example of FIG. 4, the target number is 1000. Household is the first level of the hierarchical survey. The administrator user can also specify a sampling unit associated with the second stage of the hierarchical survey. For example, second stage sampling unit can be an individual within the household. The individual hierarchical surveyed is the second level of the hierarchical survey. When the administrator user creates the hierarchical survey, variables corresponding to each sampling unit of the multistage hierarchical survey are created, and are automatically populated for each hierarchical survey answer. The analysis routines then use this established hierarchy to automate the most common computations typically performed by a statistician in a statistics package.

FIG. 5 is an example of a hierarchical survey template presented to an administrator user, according to at least one embodiment. The template, once defined, represents the third level of the hierarchical survey. The template includes a plurality of nodes 500-580. Each node 500-580 corresponds to a question category such as, income, immigration, nutrition, occupation, transport, water, shelter, livestock, medical, etc. Each node 500-580 can be selected. When selected, each node 500-580 enables the administrator user to create a new question category node in the template, or to modify an existing question category node in the template. Once administrator graphical user interface creates the question category nodes 500-580, the administrator graphical user interface enables the administrator user to define questions associated with each question category node 500-580.

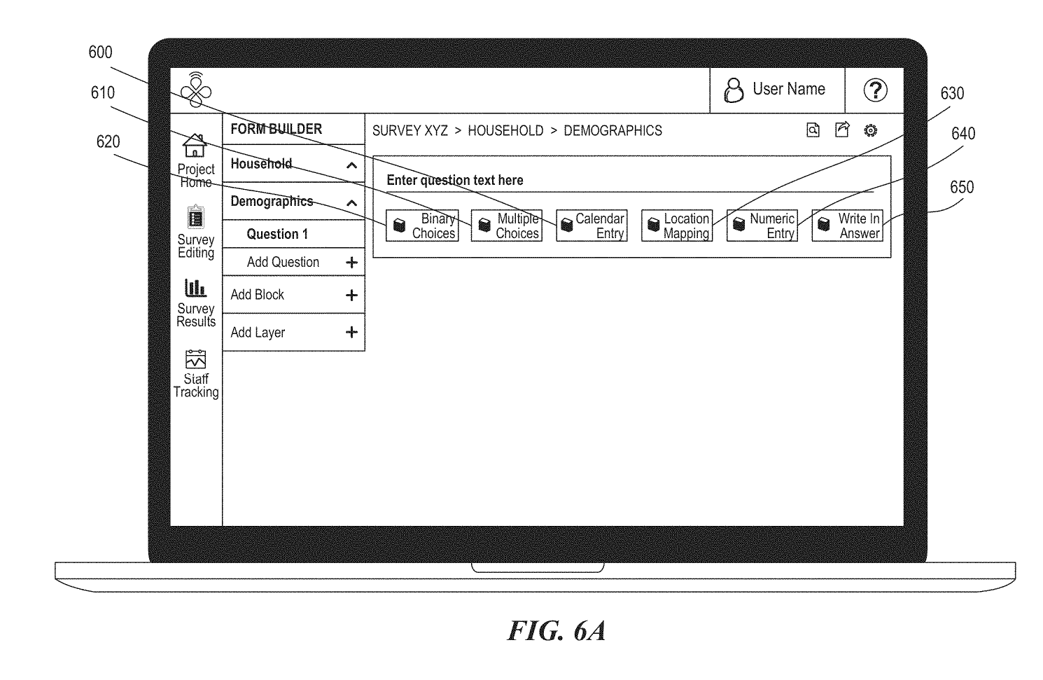

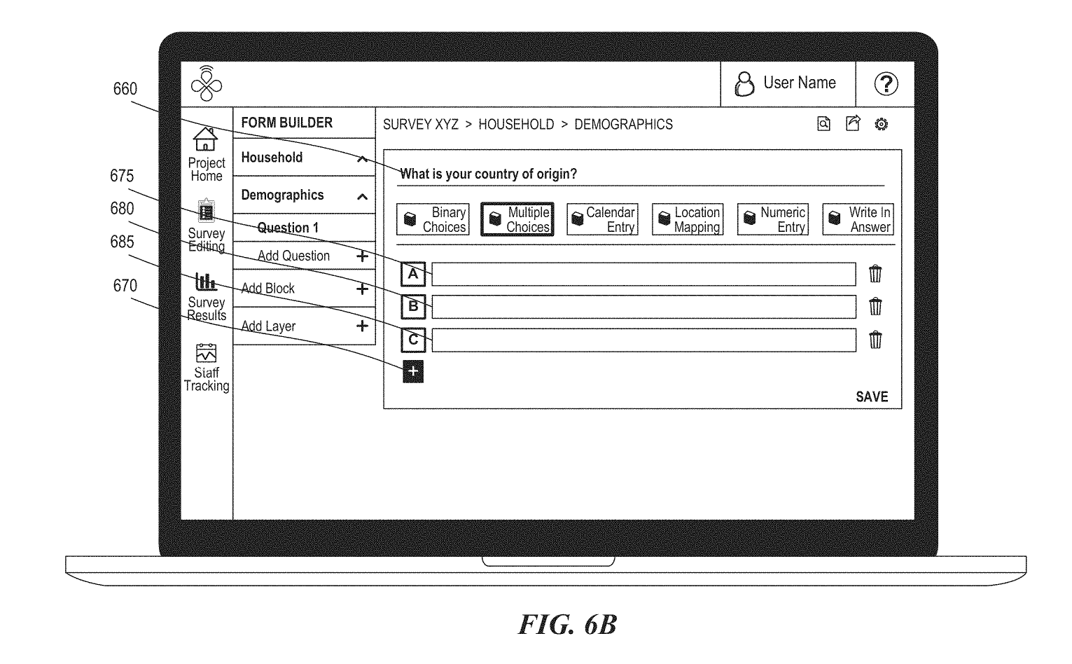

FIG. 6A-B, are an example of an administrator graphical user interface configured to formulate a question associated with a question category node 500-580, according to at least one embodiment. The administrator graphical user interface displays several selectable GUI elements 600-650, corresponding to various question types, such as a binary question, multiple-choice question, a question where the answer is a calendar entry, a question where the answer is a location, a question where the answer is numeric, or a question where the answer is free-form. Once administrator user interface receives the administrator user input, selecting one of the GUI elements 600-650, the administrator user interface enables the administrator user to formulate a question.

FIG. 6B is an example of a multiple-choice question. GUI element 660 enables the user to enter the text of the question. GUI element 670 enables the administrator user to add any number of possible answers to the multiple-choice question. GUI elements 675, 680, 685 enable the administrator user to enter the text of possible answers to the multiple-choice question.

Each question represents a single node in the level associated with the hierarchical survey. The questions can be nested questions, also known as skip logic questions. Skip logic questions are questions where the subsequent question depends on the answer to the previous question. For example, the first question can be “Are you pregnant?”. If the answer is “yes”, then the next question can be “How far along is the pregnancy?”. The first question in a skip logic question is the parent node question, and the subsequent questions are child node questions.

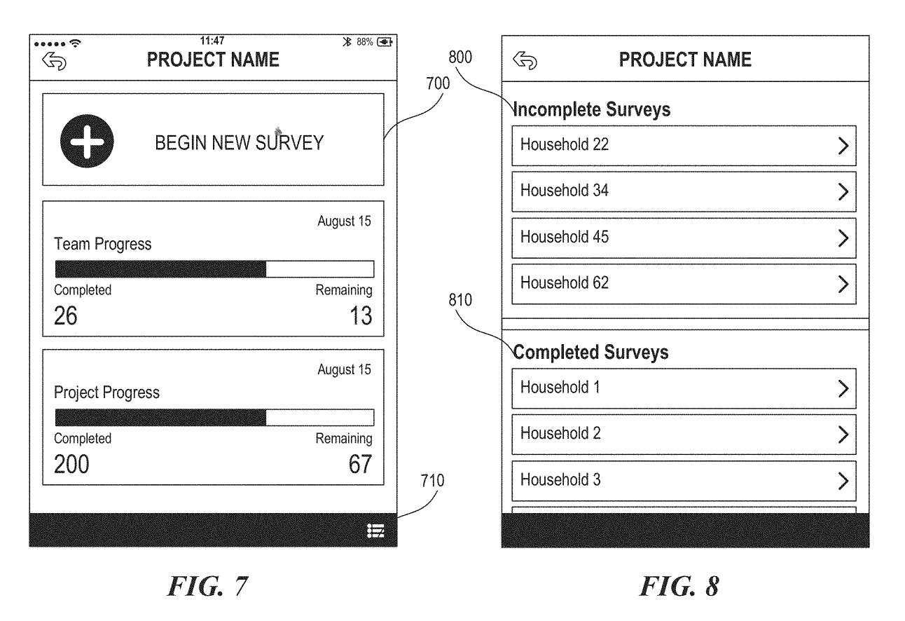

FIG. 7 is a first element of the field agent graphical user interface, associated with a field agent device 20, according to at least one embodiment. The first element of the field agent graphical user interface displays the progress of a team associated with the field agent, or of a project associated with the field agent. The first element includes a GUI element 700 which enables the field agent to begin a new hierarchical survey, and a GUI element 710 which enables the field agent user to see the list of incomplete, and complete hierarchical surveys, as displayed in FIG. 8.

FIG. 8 is a second element of the field agent graphical user interface, associated with a field agent device 20, enabling the field agent to view the hierarchical survey progress, according to at least one embodiment. The second element displays a list of complete hierarchical surveys 810, and incomplete hierarchical surveys 800, thus enabling the field agent to complete a hierarchical survey not finished by another field agent. The complete and incomplete hierarchical surveys can be color-coded. For example, the complete hierarchical surveys are displayed in green, and incomplete hierarchical surveys are displayed in yellow.

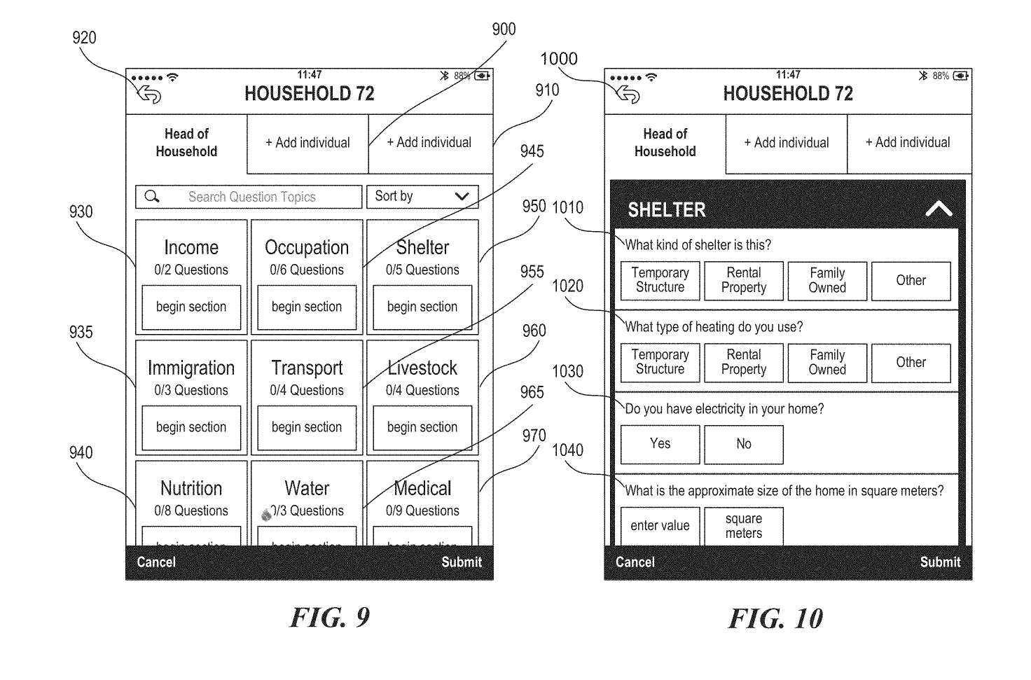

FIG. 9 is a third element of a field agent graphical user interface, associated with a field agent device 20, according to at least one embodiment. The third element represents the level comprising question category nodes 930-970, which the administrator user has previously defined. The third element displays how many questions there are in each question category node 930-970, and how many of those questions have been answered. The question category nodes 930-970 can be color-coded to indicate how many questions associated with the question category have been answered. For example, when the question category node 930-970 is red, no questions in that question had category have been answered. When the question category node 930-970 is yellow, some, but not all questions in that question category node have been answered. When the question category nodes 930-970 is green, all questions in that question category node have been answered. GUI elements 900, 910 enable the field agent to hierarchical survey additional individuals in a household. GUI elements 900, 910 enable the field agent to add as many individuals in a household is the field agent is capable to hierarchical survey. GUI element 920 enables the field agent to return to the second element of the field agent graphical user interface, without requiring the field agent to complete any of the question category nodes 930-970. When the field agent graphical user interface receives an input from the field agent selecting one of the question category nodes 930-970, the field agent graphical user interface displays the fourth element of the field agent graphical user interface.

FIG. 10 is a fourth element of the field agent graphical user interface, associated with a field agent device 20, according to at least one embodiment. The fourth element displays the level comprising the questions, i.e., question nodes, 1010-1040, associated with the selected question category node 930-970. The fourth element displays the back button 1000, which enables the field agent to go up a level in the hierarchical survey, without gathering the answers to all the questions 1010-1040 associated with the selected question category node. For example, when the back button 1000 is pressed, the field agent graphical user interface displays the third element, comprising question category nodes 930-970. Questions 1010 and 1020 are examples of a multiple-choice questions. Question 1030 is an example of a binary question. Question 1040 is an example of a question where the answer is numerical.

The field agent device 20 stores the received answers locally, until a network 40 becomes available. When the network 40 becomes available, the field agent device 20 sends the stored answers to the database 50. The database 50 can be the field manager user device 30.

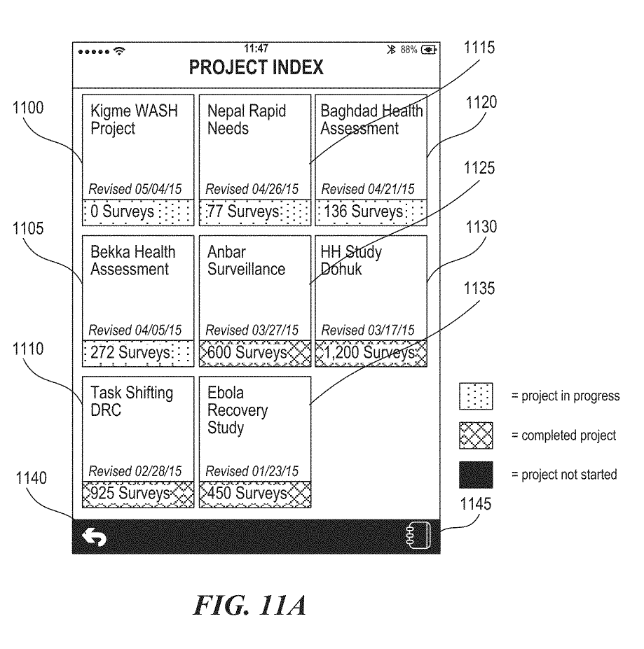

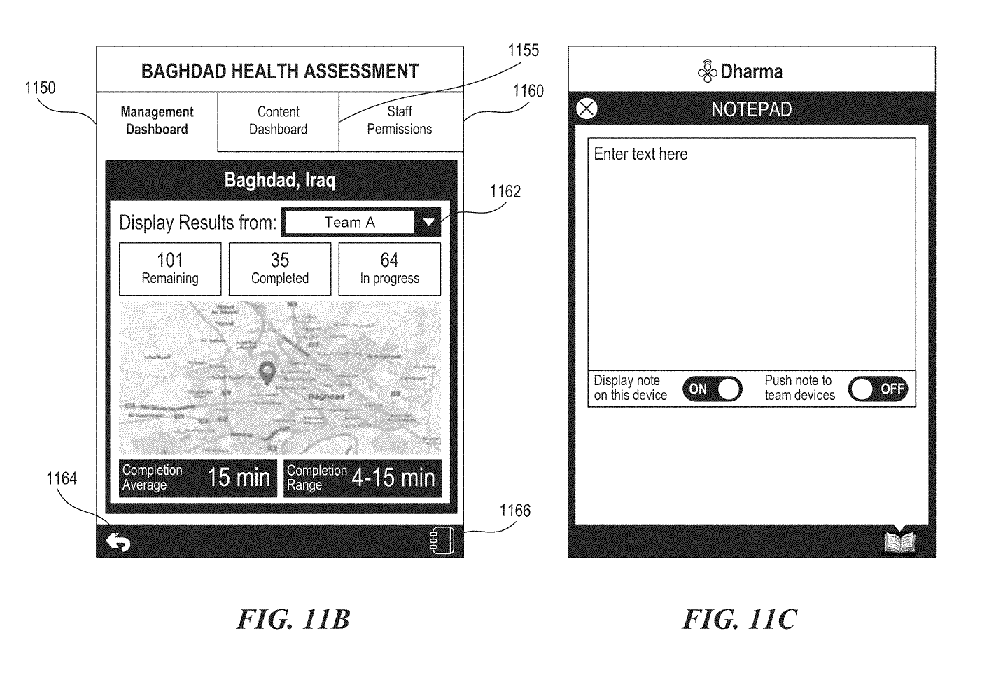

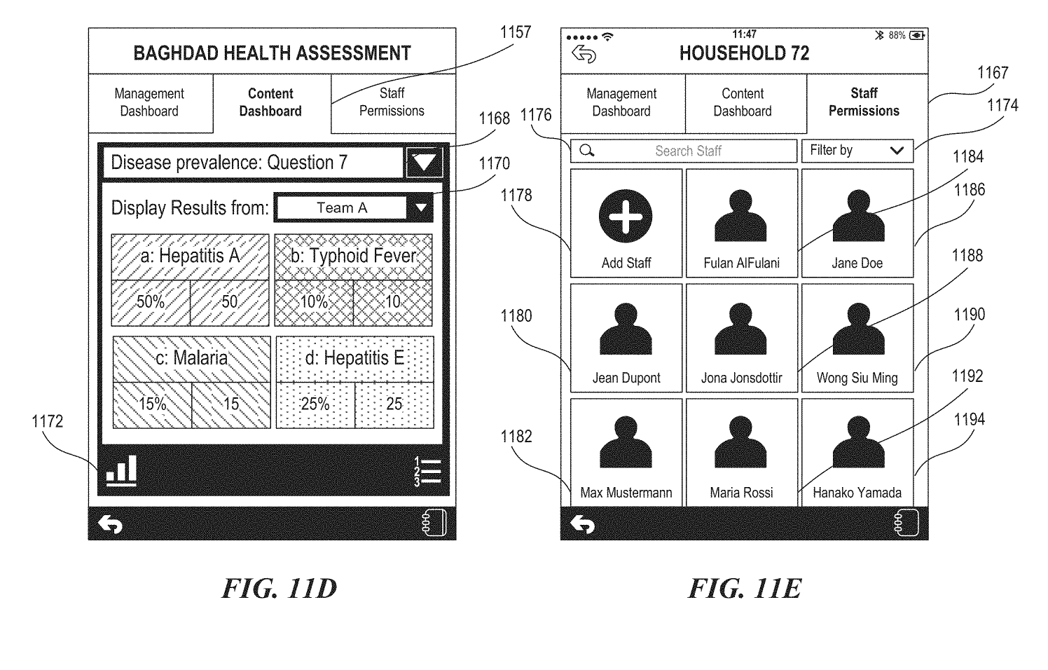

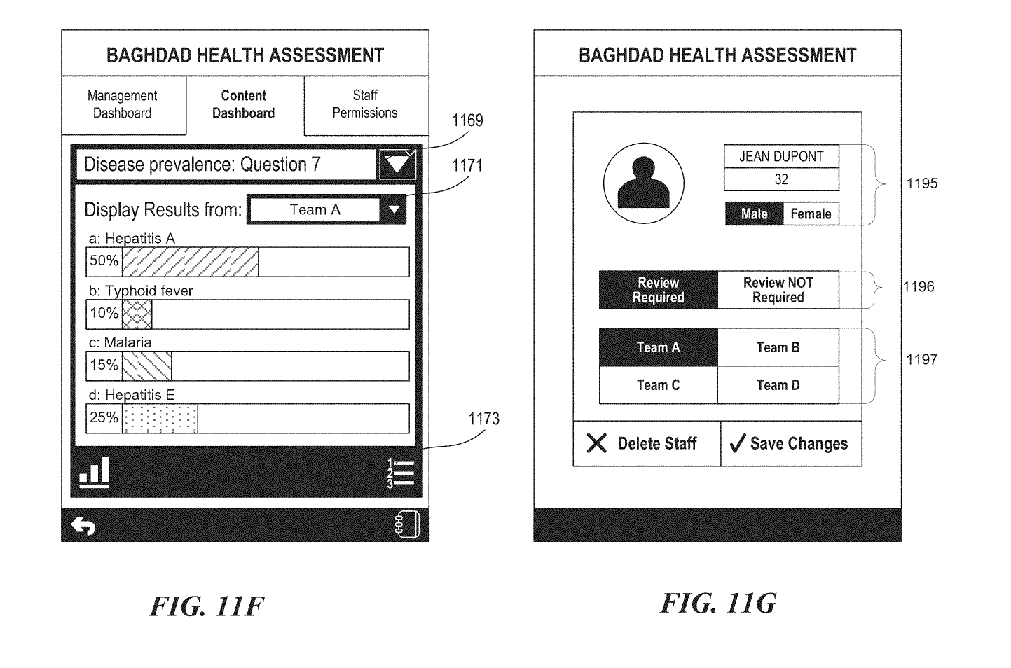

FIG. 11A is a first element of a field manager graphical user interface, associated with a field manager device 30, enabling the monitoring of a hierarchical survey progress, according to at least one embodiment. FIG. 11A displays the GUI elements 1100-1135 indicating the progress of various projects, associated with the field manager. The progress of various projects can be color-coded. For example, the completed projects are green, partially computer completed projects are yellow, and projects that have not started are red. GUI elements 1100-1135 can be selected. GUI element 1140 enables the field manager user to return to the previous screen, such as the login screen. GUI element 1145 is configured to display a notepad, as seen in FIG. 11C.

In another embodiment, the field manager graphical user interface for monitoring progress includes the progress percentage associated with each hierarchical survey, with each field agent, or with each respondent. The progress monitoring can include the progress percentage associated with a level in a hierarchical survey, or a node in a hierarchical survey. The progress percentage for a level in the hierarchical survey can be calculated per field agent, per respondent, per team, or per project. Similarly, the progress percentage for a node in the hierarchical survey can be calculated per field agent, per respondent, per team, or per project.

The progress monitoring can include an average time to complete a level associated with the hierarchical survey, a percentage of questions answered at each level of the hierarchical survey, an average time to the hierarchical survey completion, a percentage of completed hierarchical surveys, etc. The progress monitoring can be done per field agent, per respondent, per team, or per project. The progress monitoring can be done using any permutation of the described parameters.

FIG. 11B is the field manager dashboard associated with the field manager graphical user interface, associated with a field manager device 30, according to at least one embodiment. When the field manager graphical user interface receives selection of one of the GUI elements 1100-1135 from the user, the field manager graphical user interface displays the field management dashboard 1150 in FIG. 11B. GUI element 1162 enables a user to view the progress of a team associated with the project. GUI element 1164 enables the user to return to the previous screen, such as the project progress screen of FIG. 11A. GUI element 1166 is configured to display a notepad, as seen in FIG. 11C. GUI element 1155 corresponds to contact dashboard, and GUI elements 1160 corresponds to staff permissions. Both GUI elements 1155 and 1160 can be selected.

FIG. 11C is a notepad enabling the field manager to enter comments associated with a team, a project, or a group of projects. The notes can be private, that is associated only with the field manager device, or can be shared with various team that the field manager selects.

FIG. 11D is the content dashboard associated with the field manager graphical user interface, according to at least one embodiment. When the field manager graphical user interface receives selection of the GUI element 1155 in FIG. 11A, the field manager graphical user interface displays the content dashboard 1157 in FIG. 11D, which includes the analytics based on the hierarchical survey answers received so far. GUI element 1168 enables the field manager user to select a question for which he wants to see the analytics. GUI element 1168 can also enable the field manager user to select a subset of questions, or to select all the questions for which he wants to see the analytics. GUI element 1170 enables the field manager user to select a team, a subset of teams, or all of the teams for which he wants to see the analytics. The analytics can be displayed as the total number of same answers received, and the percentage of same answers received out of all the answers received. GUI element 1172 enables the field manager user to change the analytics visualization to a different visualization, such as a bar graph display, a pie chart, a hollow pie chart, a line graph, etc.

FIG. 11E is the staff permissions dashboard associated with the field manager graphical user interface, according to at least one embodiment. When the field manager graphical user interface receives selection of the GUI element 1160 in FIG. 11A, the field manager graphical user interface displays the staff permissions dashboard 1167 in FIG. 11E. The staff permissions dashboard 1167 includes the list of field agents associated with the field manager user. GUI element 1174 enables the field manager user to view field agents associated with a particular project, or a particular team, a subset of projects, a subset of teams, or all field agents associated with the field manager user. GUI element 1176 enables the field manager user to search for a particular field agent. GUI elements 1178-1194 can be selected. GUI element 1178 enables the field manager user to add an additional field agent to a project, a subset of projects, a team, or a subset of teams. GUI elements 1180-1194 enable the field manager user to manage permissions and privileges associated with a field agent.

FIG. 11F is the content dashboard associated with the field manager graphical user interface, according to at least one embodiment. When the field manager graphical user interface receives selection of the GUI element 1155 in FIG. 11A, the field manager graphical user interface can display the content dashboard 1157 in FIG. 11D, which includes the analytics based on the hierarchical survey answers received so far. GUI element 1169 enables the field manager user to select a question for which he wants to see the analytics. GUI element 1169 can also enable the field manager user to select a subset of questions, or to select all the questions for which he wants to see the analytics. GUI element 1171 enables the field manager user to select a team, a subset of teams, or all of the teams for which he wants to see the analytics. The analytics can be displayed as a bar graph of the percentage of same answers received out of all the answers received. GUI element 1173 enables the field manager user to change the analytics visualization to a different visualization, such as a bar graph display, a pie chart, a hollow pie chart, a line graph, etc.

FIG. 11G is a field manager graphical user interface enabling the field manager user to manage permissions and privileges associated with a field agent, according to at least one embodiment. GUI element 1195 enables the field manager user to specify personal attributes associated with a field agent, such as a name, age, or gender. GUI element 1196 enables the field manager user to specify a protocol associated with the field agent, such as whether the field agent needs to be interviewed before joining a team, the field agent's performance needs to be reviewed, whether the field agents team assignments need to be reviewed, etc. GUI elements 1197 enables the field manager user to assign the field agent to different teams, different projects, or give the field agent access to different hierarchical surveys.

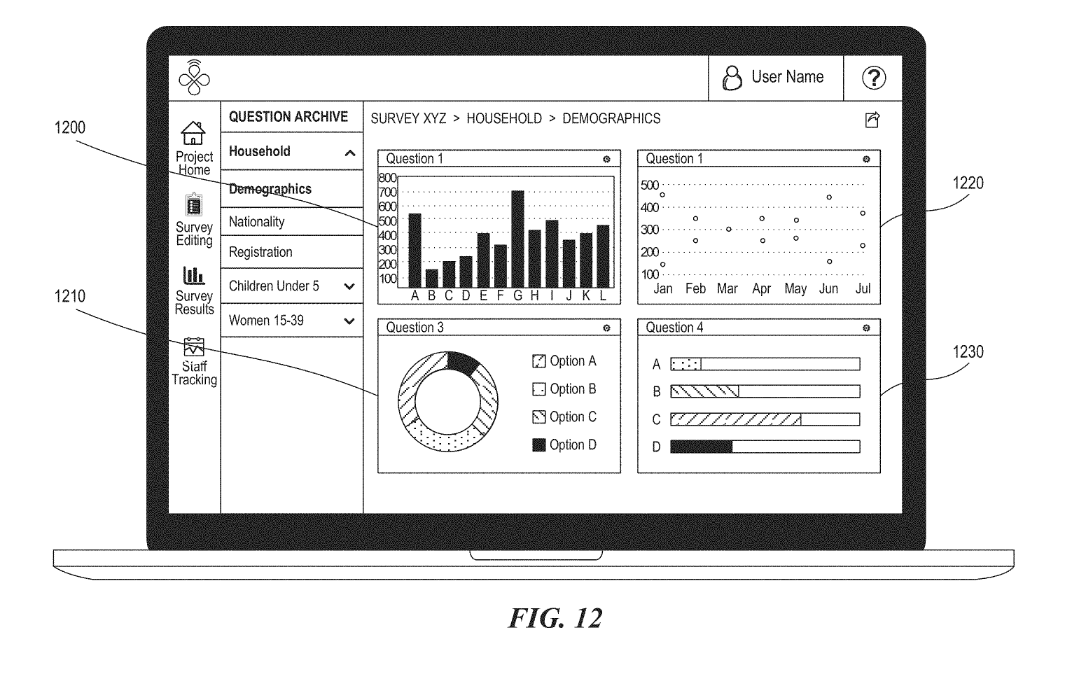

FIG. 12 is an analytics graphical user interface displaying the analytics computed based on the answers received, according to at least one embodiment. Once the answers are stored in database 50, a device computes the data analytics. The device can be an administrator user device 10, a field manager user device 30, or any device authorized to access database 50. Once the analytics are computed, any device authorized to access database 50 can view the analytics, such as the administrator user device 10, or a field manager user device 30. The analytics can be displayed as a vertical bar graph 1200, a hollow pie chart 1210, a scatter point graph 1220, a horizontal bar graph 1230, a line graph, a pie chart, etc.

When the administrator user creates the hierarchical survey, variables corresponding to each sampling unit of the multistage hierarchical survey are created, and are automatically populated for each hierarchical survey answer. The analysis routines then use this established hierarchy to automate the most common computations typically performed by a statistician in a statistics package. For example, consider a household hierarchical survey performed in a sample of villages chosen to represent an entire study region. A naïve analysis of the hierarchical survey answers would not take into account the covariances introduced by this sampling strategy, thus requiring a time consuming manual analysis of each question in order to arrive at the correct results and uncertainty estimates. The computing of the analytics in this invention automates the manual process.

The device normalizes sampling weights associated with the answers based on a sampling unit and a number of sampling stages associated with the hierarchical survey. The device calculates a best fit curve to approximate the answers, where the best fit curve has a minimal standard error. The device can update the analytics, if the new answers coming. According to at least one embodiment, the database 50 can push new answers to the device, as soon as the database 50 receives an answer. According to another embodiment, the device queries the database if any new answers have been uploaded. When the device receives the new answers from the database 50, the device updates the analytics.

### Computer

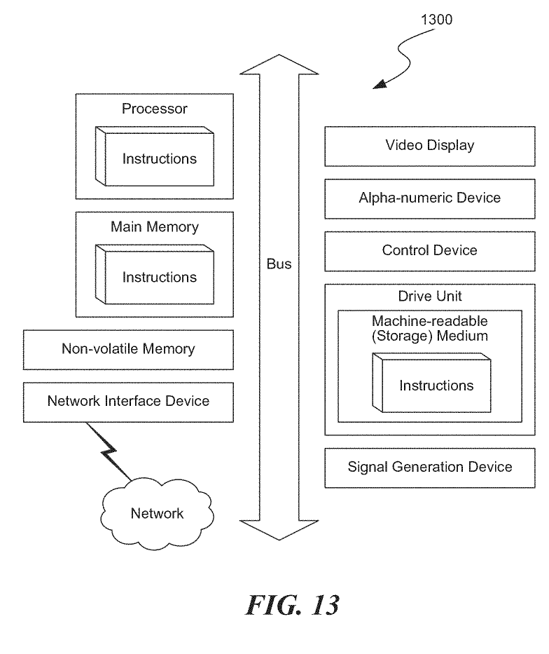

FIG. 13 is a diagrammatic representation of a machine in the example form of a computer system 1300 within which a set of instructions, for causing the machine to perform any one or more of the methodologies or modules discussed herein, may be executed.

In the example of FIG. 13, the computer system 1300 includes a processor, memory, non-volatile memory, and an interface device. Various common components (e.g., cache memory) are omitted for illustrative simplicity. The computer system 1300 is intended to illustrate a hardware device on which any of the components described in the example of FIGS. 1-12 (and any other components described in this specification) can be implemented. The computer system 1300 can be of any applicable known or convenient type. The components of the computer system 1300 can be coupled together via a bus or through some other known or convenient device.

This disclosure contemplates the computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1300 may include one or more computer systems 1300; be unitary or distributed; span multiple locations; span multiple machines; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1300. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1300. The interface can include an analog modem, isdn modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 13 reside in the interface.

In operation, the computer system 1300 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. (canceled)

2. (canceled)

3. (canceled)

4. A method to create a hierarchical survey for a field agent, said method comprising:
generating an administrator graphical user interface, associated with an administrator user device, to guide an administrator user in creating said hierarchical survey, said hierarchical survey comprising a plurality of levels, wherein each level comprises a node, wherein a first subset of said plurality of levels corresponds to a sampling unit associated with a hierarchical survey stage, and wherein a second subset of said plurality of levels corresponds to a question category, and wherein a third subset of said plurality of levels corresponds to a question;
providing a hierarchical survey template to said administrator user thereby enabling said administrator user to:
modify a pre-existing node associated with a level in said plurality of levels associated with said hierarchical survey, and
create a new node associated with said level in said plurality of levels associated with said hierarchical survey; and
transmitting, from said administrator user device to a field manager device, said hierarchical survey via a peer-to-peer network.

5. The method of claim 4, wherein a first level associated with said plurality of levels comprises a first node corresponding to a sampling unit associated with a first hierarchical survey stage, wherein a second level associated with said plurality of levels comprises a second node corresponding to a sampling unit associated with a second hierarchical survey stage, wherein a third level associated with said plurality of levels comprises a third node corresponding to said question category, and wherein a fourth level associated with said plurality of levels comprises said node corresponding to said question.

6. The method of claim 4, said hierarchical survey further comprising a subsequent level, said subsequent level comprising said node corresponding to said question, said question dependent on an answer associated with said question associated with a previous level.

7. The method of claim 4, wherein said peer-to-peer network connection comprises a mesh network.

8. The method of claim 4, wherein said transmitting from said administrator user device to said field manager device comprises using a short range wireless communication protocol.

9. The method of claim 4, further comprising:
creating a user category comprising administrator user privileges, field manager user privileges, and field agent user privileges; and
associating a user ID with said user category.

10. The method of claim 9, wherein said administrator user privileges comprise an access to create said hierarchical survey, an access to monitor hierarchical survey progress, and an access to view hierarchical survey analytics.

11. The method of claim 9, wherein said field manager user privileges comprise an access to monitor hierarchical survey progress, and an access to view hierarchical survey analytics.

12. The method of claim 9, wherein said field agent user privileges comprise an access to record answers to said hierarchical survey.

13. A method to gather field data for a field agent, said method comprising:
configuring a field agent graphical user interface, associated with a field agent device, to correspond to a hierarchical survey, said hierarchical survey comprising a plurality of levels, wherein each level comprises a node, said field agent graphical user interface configured to enable said field agent to navigate among said plurality of levels and among said node associated with said plurality of levels, without having to complete said node before switching to another node; and
when a new answer to a question associated with said hierarchical survey is entered and a peer-to-peer network is available, propagating said new answer to a database using said peer-to-peer network.

14. The method of claim 13, wherein when said answer to said hierarchical survey is entered and said peer-to-peer network is not available, storing said new answer on said field agent device until said peer-to-peer network becomes available.

15. The method of claim 13, wherein said peer-to-peer network comprises a mesh network.

16. The method of claim 13, wherein said database comprises a device associated with a field manager.

17. (canceled)

18. (canceled)

19. (canceled)

20. (canceled)

21. (canceled)

22. A method comprising:
transmitting answers associated with a plurality of devices to a database via a peer-to-peer network;
based on said answers, computing analytics to display in an analytics graphical user interface.

23. The method of claim 22, wherein said peer-to-peer network comprises a mesh network.

24. The method of claim 22, wherein said transmitting answers associated with said plurality of devices comprises using a short range wireless communication protocol.

25. The method of claim 22, wherein said generating comprises:
normalizing sampling weights associated with said answers based on a sampling unit and a number of sampling stages associated with said hierarchical survey.

26. The method of claim 22, wherein said generating comprises:
calculating a best fit curve to approximate said answers, said best fit curve having a minimal standard error.

27. The method of claim 22, wherein said computing comprises:
without querying said a database, receiving new answers from said database; and
updating said analytics based on said new answers.

28. The method of claim 22, wherein said computing comprises:
querying said database if new answers have been uploaded; and
upon receiving said new answers from said database, updating said analytics.
